(19) United States
(12) Patent Application Publication
(10) Pub. No.: US 2024/0055650 A1
(43) Pub. Date: Feb. 15, 2024

(54) SULFIDE COMPOSITE ELECTROLYTES FOR SOLID-STATE LITHIUM BATTERIES

(71) Applicant: UNIVERSITY OF LOUISVILLE RESEARCH FOUNDATION, INC., Louisville, KY (US)

(72) Inventors: Hui Wang, Louisville, KY (US); Yang Li, Louisville, KY (US); Thad Druffel, Louisville, KY (US)

(73) Assignee: UNIVERSITY OF LOUISVILLE RESEARCH FOUNDATION, INC., Louisville, KY (US)

(21) Appl. No.: 18/014,919

(22) PCT Filed: Jul. 9, 2021
(86) PCT No.: PCT/US21/41036

§ 371 Date: Jan. 6, 2023

Related U.S. Application Data
(60) Provisional application No. 63/050,287, filed on Jul. 10, 2020.

(51) Int. Cl. H01M 10/056; H01M 10/052

(52) U.S. Cl. CPC H01M 10/056; H01M 10/052; H01M 2300/0082; H01M 2300/0088; H01M 2300/0068

(57) ABSTRACT

A sulfide-based composite electrolyte for use in solid-state batteries and methods for making same. In some embodiments, the sulfide-based composite electrolyte comprises the combination of an inorganic sulfide Li argyrodite (Li₇PS₆) with a polyvinylidenefluoride-co-hexafluoropropylene (PVDF-HFP) polymer.

### CROSS-REFERENCE TO RELATED APPLICATIONS

This international patent application claims the benefit of and priority to U.S. Provisional Patent Application Ser. No. 63/050,287, with a filing date of 10 Jul. 2020, the contents of which are fully incorporated herein by reference.

### STATEMENT OF GOVERNMENT RIGHTS

This invention was made with United States Government support under Grant No. EE0008866 awarded by the U.S. Department of Energy's Office of Energy Efficiency and Renewable Energy. The United States Government has certain rights in the invention.

### FIELD OF INVENTION

The embodiments described relate to solid electrolytes (referred to herein as “SEs” for brevity), including sulfide composite electrolytes, for use in solid-state lithium metal batteries.

### BACKGROUND

Rechargeable lithium (Li) metal batteries are considered to be an optimal choice for next-generation storage technology in order to meet the growing demand of portable electronics and electric vehicles. However, further advancement of lithium metal batteries has been hampered by safety issues, such as unavoidable Li dendrites. Dendrites are tiny, rigid-like structures that can grow inside a lithium battery and can cause serious harm by piercing certain structures in the battery (e.g. a separator) and causing internal short circuits of a cell during operation. SEs provide an alternative solution to enhance the safety performance of lithium metal batteries owing to their potential to inhibit Li dendrites.

Currently, considerable efforts have been devoted to developing various types of SEs. Among them, sulfide SEs have attracted attention due to their advantage of high ionic conductivity, for example 10⁻⁴-10⁻³ Siemens per centimeter (S cm⁻¹) at room temperature, low synthesis temperature, and cold press-induced densification. However, the conventional preparation of sulfide SEs is hampered by several problems, including: (1) chemical instability in air due to the hydrolysis reaction with water; and (2) electrochemical instability with metallic Li anode as well as oxide cathode materials (e.g., LiCoO₂).

Some conventional approaches have focused on the use of composite electrolytes containing oxide inorganic conductors. However, these conventional approaches are quite challenging and expensive. For example, some of the conventional approaches require a stringent synthesis process in a glove box with ultralow oxygen/water levels due to the air instability of sulfides, which increases the cost for material processing of composite electrolytes and the difficulty for fabricating solid-state batteries. Moreover, the selection of an appropriate solvent is also challenging. For example, the ionic conductivity of sulfide SEs significantly decreases when they are dispersed and re-dried from polar solvents, such as dimethylformamide (DMF), acetone, N-methyl-2-pyrrolidinone (NMP), and ethers, which are commonly used to dissolve polymers.

Accordingly, there is a significant need for a sulfide composite electrolyte (SCE) that exhibits chemical and electrochemical stability, flexibility, and desirable electrochemical performance. Along with other features and advantages outlined herein, the SCEs for solid-state lithium batteries according to multiple embodiments and alternatives meet these and other needs. In doing so, the SCEs described herein exhibit superior ionic conductivity, prolonged cycle life, enhanced stability, suppression of Li dendrites, and provide desirable cycling capacity and rate performance.

### SUMMARY OF EMBODIMENTS

Multiple embodiments and alternatives are disclosed herein for a sulfide composite electrolyte (referred to herein as “SCE” or “SCEs” for brevity) that exhibits desired stability, flexibility, and superior electrochemical performance, and methods for making same. In some embodiments, a polymer is introduced as a matrix to prepare the SCE, and an inorganic sulfide lithium argyrodite is used as a sulfide SE. Exemplary, non-limiting polymers include fluorinated polymers (such as polyvinylidenefluoride-co-hexafluoropropylene (PVDF-HFP) and polyvinylidene fluoride (PVDF)), methyl methacylate-based polymers (such as PMMA), vinyl polymers (such as PAN), and ethylene-based polymers (such as poly(ethylene oxide) (PEO)). In addition, it is expected that other polymers will be suitable for use in the synthesis of the SCE's, and therefore are within the scope of present embodiments. In some embodiments, the inorganic sulfide lithium argyrodite is chosen from the group consisting of LiₘPSₙXₒ, LiₘPSₙXₒYₒ and LiₘPSₙ, where m is a number in the range of 6-7, n is a number in the range of 5-6, X represents at least one halide, Y represents at least one halide that is different than X, and o is a number in the range of 0-2. In some embodiments, the halides, represented by X or Y, are chosen from the group consisting of Cl, Br, and I. In some embodiments, the sulfide composite electrolyte further comprises a salt (such as lithium bis(trifluoromethanesulfonyl)imide (LiTFSI), lithium bis(fluorosulfonyl)imide (LiFSI), and lithium hexafluorophosphate (LiPF₆) as non-limiting examples) which enhances interfacial properties.

According to multiple embodiments and alternatives, the SCE is prepared by mixing an inorganic sulfide lithium argyrodite (which in some embodiments is formed by wet chemical synthesis), a polymer, and a salt in a solvent (such as tetrahydrofuran (THF) as a non-limiting example), casting, and then heat treating to remove the solvent. In some embodiments, the thickness of the polymer/salt and the inorganic sulfide lithium argyrodite membranes is in a range of about 50 μm to about 200 μm, and in other embodiments the range is about 100 μm to about 150 μm. The liquid synthesis method, according to multiple embodiments and alternatives, preserves the ionic conductivity of the sulfide electrolyte when dispersing in the solvent. Accordingly, in the synthesized structure of the SCE, the inorganic sulfide lithium argyrodite is embedded in the matrix of the polymer.

In an exemplary embodiment, the SCE exhibits a desired ionic conductivity of 1.11×10⁻⁴ S cm⁻¹ at room temperature (e.g. about or greater than 22° C.). Likewise, symmetric cells incorporating a SCE, according to multiple embodiments and alternatives, exhibit the ability to suppress Li dendrites for long-term cycling of 1000 h at 0.2 mA cm⁻¹. In addition, the electrochemical stability induced by the SCE disclosed herein exhibits desired specific and cycling stabilities over long cycles. These favorable features, along with other advantages described herein, indicate the SCE described herein provides significant advantages for use in next-generation solid-state flexible Li batteries.

### BRIEF DESCRIPTION OF THE FIGURES

The drawings and embodiments described herein are illustrative of multiple alternative structures, aspects, and features of the multiple embodiments and alternatives disclosed herein, and they are not to be understood as limiting the scope of any of these embodiments and alternatives. It will be further understood that the drawing figures described and provided herein are not to scale, and that the embodiments are not limited to the precise arrangements and instrumentalities shown.

FIG. 1(A) shows a scanning electron microscope (SEM) image of a membrane lacking a SCE. FIG. 1(B) shows a SEM image of a SCE, according to multiple embodiments and alternatives. FIG. 1(C) shows a SEM image of the cross-section of a SCE, according to multiple embodiments and alternatives. FIG. 1(D) shows an enlarged SEM image of a SCE and the corresponding elemental mappings of fluorine (F), phosphorous (P), and sulfur (S) distributions in the SCE membrane, according to multiple embodiments and alternatives. FIG. 1(E) illustrates the prepared SCE membrane.

FIG. 2 shows a SEM image of a SCE, according to multiple embodiments and alternatives.

FIG. 3(A) shows a comparison of the x-ray diffraction patterns (XRD) of a SCE, PVDF-HFP/LiTFSI, Li₇PS₆ (LPS), and PVDF-HFP, according to multiple embodiments and alternatives. FIG. 3(B) shows a comparison of the Raman spectra of a SCE, PVDF-HFP/LiTFSI, LPS, and PVDF-HFP, according to multiple embodiments and alternatives. FIG. 3(C) shows a comparison of the Fourier transform infrared spectra (FT-IR) of a SCE, PVDF-HFP/LiTFSI, LPS, and PVDF-HFP, according to multiple embodiments and alternatives. FIG. 3(D) shows a comparison of the thermogravimetric analysis (TGA) of a SCE, PVDF-HFP/LiTFSI, LPS, and PVDF-HFP, according to multiple embodiments and alternatives.

FIG. 4 shows the XRD pattern of LPS.

FIG. 5(A) shows the x-ray photoelectron spectra (XPS) of S 2p for LPS and FIG. 5(B) shows the XPS of P 2p for LPS. FIG. 5(C) shows the XPS of S 2p for a SCE, according to multiple embodiments and alternatives. FIG. 5(D) shows the XPS of P 2p for a SCE, according to multiple embodiments and alternatives.

FIG. 6(A) is a schematic illustration of a SCE, according to multiple embodiments and alternatives. FIG. 6(B) shows Arrhenius plots of LPS, a SCE, and PVDF-HFP/LiTFSI, according to multiple embodiments and alternatives. FIG. 6(C) shows the electrochemical impedance spectroscopy (EIS) spectra of a SCE with 10 wt % LPS at various temperatures of 30, 60, and 90° C. FIG. 6(D) shows the ionic conductivity of a SCE with various contents of LPS (0, 10, 20, and 30 wt %), according to multiple embodiments and alternatives.

FIG. 7(A) shows a cross-section SEM image and the energy-dispersive spectroscopy (EDS) mapping images a SCE membrane with 10 wt % LPS, according to multiple embodiments and alternatives. FIG. 7(B) shows a cross-section SEM image and the energy-dispersive spectroscopy (EDS) mapping images a SCE membrane with 20 wt % LPS, according to multiple embodiments and alternatives. FIG. 7(C) shows a cross-section SEM image and the energy-dispersive spectroscopy (EDS) mapping images of a SCE membrane with 30 wt % LPS, according to multiple embodiments and alternatives.

FIG. 8(A) shows the cycling performance of a Li symmetric cell with a SCE, according to multiple embodiments and alternatives, at the current density of 0.2 mA cm⁻² (areal capacity of 0.1 mAh cm⁻²). FIG. 8(B) shows a comparison of symmetric cells cycling with PVDF-HFP/LiTFSI and a SCE, according to multiple embodiments and alternatives, at the current density of 0.5 mA cm⁻² (0.25 mAh cm⁻²). FIG. 8(C) shows the symmetric Li∥SCE∥Li cell cycled at various current densities of 0.1, 0.2, 0.5, and 0.8 mA cm⁻², according to multiple embodiments and alternatives.

FIG. 9 shows the zoomed-in voltage profiles for typical cycles of a Li symmetric cell with a SCE, according to multiple embodiments and alternatives, under a current density of 0.2 mA cm⁻² (0.1 mAh cm⁻²).

FIG. 10(A) shows the EIS spectra of a symmetric Li cell with a SCE, according to multiple embodiments and alternatives, before cycling and after 180 cycles. FIG. 10(B) shows the EIS spectra of a symmetric Li cell with a PVDF-HFP/LiTFSI polymer electrolyte before cycling and after 100 cycles.

FIG. 11(A) shows the SEM image of a Li metal surface of a SCE, according to multiple embodiments and alternatives, after cycling. FIG. 11(B) shows the SEM image of a Li metal surface for a PVDF-HFP/LiTFSI polymer electrolyte after cycling.

FIG. 12(A) shows the cell cycling performance and coulombic efficiency of a LFP∥Li cell using PVDF-HFP/LiTFSI and a SCE at 0.2 C, according to multiple embodiments and alternatives. FIG. 12(B) shows a comparison of the rate performance for cells with a SCE, according to multiple embodiments and alternatives, and the PVDF-HFP/LiTFSI polymer electrolyte at current rates of 0.2, 0.3, 0.5, 0.8, and 1 C. FIG. 12(C) shows the voltage profiles of a LFP∥SCE∥Li cell, according to multiple embodiments and alternatives, at various current rates.

FIG. 13(A) is a SEM image from the Li anode surface of a LFP/Li cell with a SCE after cycling, according to multiple embodiments and alternatives. FIGS. 13(B) to 13(F) show the XPS spectra C 1s, F 1s, S 2p, P 2p, and Li 1s obtained from the Li-metal surface of a LFP/Li cell with a SCE after cycling, according to multiple embodiments and alternatives.

FIGS. 14(A) and 14(B) show the XPS spectra of P 2p and Li is obtained from the Li metal surface of a LFP/Li cell with PVDF-HFP/LiTFSI after cycling, according to multiple embodiments and alternatives.

FIGS. 15(A) and 15(B) show the SEM images of the surface of a cycled Li anode from a LFP/Li cell assembled with a SCE, according to multiple embodiments and alternatives. FIGS. 15(C) and 15(D) show the SEM images of the cross-section of a cycled Li anode from a LFP/Li cell assembled with a SCE, according to multiple embodiments and alternatives. FIGS. 15(E) and 15(F) show the SEM images of the surface of a cycled Li anode from a LFP/Li cell assembled with PVDF-HFP/LiTFSI, according to multiple embodiments and alternatives. FIGS. 15(G) and 15(H) show the SEM images of the cross-section of a cycled Li anode from a LFP/Li cell assembled with PVDF-HFP/LiTFSI, according to multiple embodiments and alternatives.

FIG. 16(A) shows the EIS spectra of a composite electrolyte with a SCE, according to multiple embodiments and alternatives. FIG. 16(B) shows the charge-discharge curve of a solid-state Li battery using a composite electrolyte, according to multiple embodiments and alternatives, as a solid electrolyte.

FIG. 17 shows the EIS spectra of a composite electrolyte with a SCE, according to multiple embodiments and alternatives.

### MULTIPLE EMBODIMENTS AND ALTERNATIVES

A sulfide composite electrolyte (SCE), according to multiple embodiments and alternatives, is a promising candidate for use in solid-state lithium batteries. Likewise, methods for making SCEs, according to multiple embodiments and alternatives, are more efficient and easier to prepare than conventional synthesis methods. Moreover, the synthesized SCEs described herein address the two main challenges from the practical application of SCEs: (1) the chemical instability in air due to the hydrolysis reaction with water and (2) the electrochemical instability with metallic Li anode as well as oxide cathode materials. Accordingly, the SCEs described herein are promising candidates for achieving high-performance solid-state lithium batteries.

According to multiple embodiments and alternatives, the SCE comprises an inorganic sulfide lithium argyrodite, a polymer, and a salt. In some embodiments, the inorganic sulfide lithium argyrodite is chosen from the group consisting of LiₘPSₙXₒ, LiₘPSₙXₒYₒ and LiₘPSₙ, where m is a number in the range of 6-7, n is a number in the range of 5-6, X represents at least one halide, Y represents at least one halide that is different than X, and o is a number in the range of 0-2. In some embodiments, the polymer is chosen from the group consisting of fluorinated polymers, methyl methacylate-based polymers, vinyl polymers, and ethylene-based polymers. In some embodiments, the salt is a lithium salt, such as LiTFSI, LiFSI, and LiPF₆ as non-limiting examples.

In an exemplary embodiment, the SCE membrane prepared in accordance with the teachings herein exhibits anionic conductivity of 1.11×10⁻⁴ S cm⁻¹ at room temperature. Lithium symmetric cells incorporating the SCE achieved stable cycling of 1000 h at 0.2 mA cm⁻² and delivered a desirable specific capacity of 160 mAg g⁻¹ over 150 cycles.

In some embodiments, SCEs are synthesized using wet chemical synthesis of the inorganic sulfide lithium argyrodite, which involves dissolving a stoichiometric mixture of pre-cursors in ethanol (as a non-limiting example) and stirring the mixture to form a mixed solution. Optionally, mixing is performed through methods and/or with products known in the art, including without limitation, ultrasonic mixing. Subsequently, solvent is removed from the mixed solution. As desired, evaporation can be performed by at least one of drying the mixed solution above 22° C. or by exposing the mixed solution to a low humidity/oxygen-less environment. In some embodiments, such a low humidity/oxygen-less environment is characterized by a relative humidity between 0-40% and an oxygen level between 0-20 vol %, which as desired may be achieved under vacuum. Following the evaporating step, the mixed solution is annealed, wherein annealing can be performed optionally in a low humidity/oxygen-less environment as described above. In some embodiments, the SCE composite is prepared by mixing the inorganic sulfide lithium argyrodite, the polymer, and the salt in a solvent (such as THF as a non-limiting example), casting, and then removing the solvent. In some embodiments, the thickness of the polymer/salt and SCE membranes is between about 50 μm to about 200 μm.

All examples provided herein are meant as illustrative of various aspects of multiple embodiments and alternatives associated with the synthesis and utilization of sulfide composite electrolytes. These examples are non-limiting and merely characteristic of multiple alternative embodiments as described and claimed or to-be-claimed herein.

### Example 1—Synthesis of Composite Electrolyte, LPS/PVDF-HFP/LiTFSI

Synthesis of Li₇PS₆ (LPS) solid electrolyte—A stoichiometric ratio of Li₂S (99.9%, Alfa Aesar) and β-Li₃PS₄ (1:1) was dissolved in ethanol and stirred for 2 h. The solution was then treated at 90° C. to remove the ethanol under vacuum and annealed at 200° C. for 1 h.

Preparation of Composite Electrolyte (LPS/PVDF-HFP/LiTFSI)—LiTFSI (99.99%, VWR) and PVDF-HFP (M_{w}: 400000, 99.9%, Sigma-Aldrich) (1:2 weight ratio) were dissolved in THF by ultrasonic agitation to form a homogeneous solution. A desired amount of LPS (10, 20, and 30 wt %) was then added. The mixture was sonicated for 3 h and cast onto a Petri dish. The SCE membrane was finally obtained by evaporating the THF at room temperature for 12 h and further in a vacuum oven for 6 h, and then stored in an inert gas atmosphere (e.g an argon-filled glovebox (≤0.1 ppm H₂O and O₂)).

Characterizations—As discussed in more detail below, the morphology of the LPS SE and SCE membranes was characterized by scanning electron microscope (SEM, TESCAN Vega3). Raman spectroscopy was obtained by a Renishaw inVia Raman/PL Microscope with 632.8 nm laser. X-ray diffraction (XRD), with a Bruker D8 Discover was used for phase identification with nickel-filtered Cu Kα radiation (λ=1.5418 Å) ranging from 10 to 70°. The interfacial properties were recorded by X-ray photoelectron spectroscopy (XPS, Thermo VG Scientific).

The ionic conductivity of the prepared SCE was determined from room temperature to 90° C. by a potentiostat (Bio-Logic VSP300). Electrochemical impedance spectroscopy (EIS) was performed in the frequency range of 5 MHz to 0.1 Hz. The symmetric and the LiFePO₄ (LFP)∥Li cells with the SCE were tested by a Neware battery tester at room temperature. For the preparation of the cathode, a homogeneous slurry containing LFP, Super P, and PVDF (80:10:10) was prepared in N-methylpyrrolidone (NMP), which was coated on aluminum foil and then dried at 80° C. under vacuum for 24 h. The active material loading of the prepared electrode was 1.5-2.0 mg cm⁻². Prior to electrochemical tests, 1 M LiTFSI/PC electrolyte (<5 μL) was dropped on both sides of the SCE to enhance interfacial properties. The thickness of the used PVDF-HFP/LiTFSI and SCE membranes was around 100 μm to 150 μm, respectively. All of the cell assembly processes were carried out in the glovebox. Discharge and charge tests were conducted in 2032 coin cells ranging from 2.5 to 4.0 V.

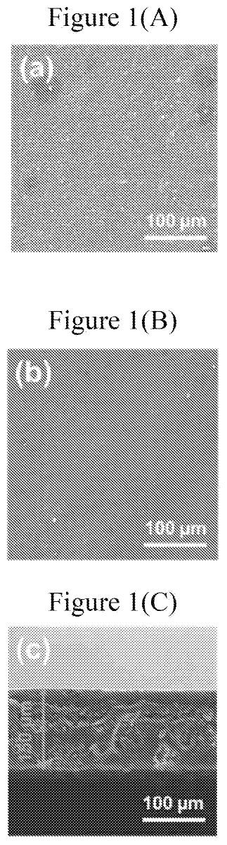

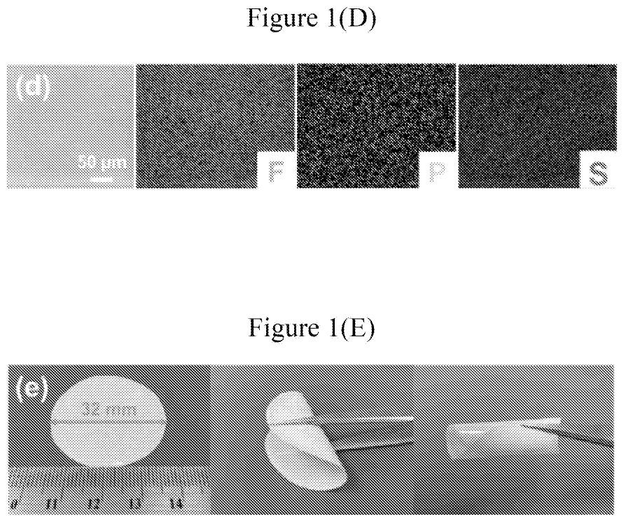

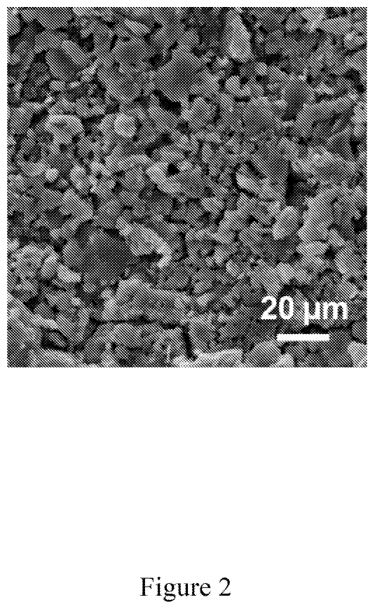

Sulfide composite electrolyte membranes were prepared by mixing the Li₇PS₆ (LPS) powder, PVDF-HFP, and LiTFSI in THF solvent, casting, and then removing the THF solvent. As shown in FIGS. 1(A) to 1(C), the morphology of the obtained SCE membrane was characterized by scanning electron microscopy (SEM). In FIG. 1(A), the PVDF-HFP/LiTFSI membrane without adding LPS powder presented a microporous morphology. In contrast, as shown in in FIGS. 1(B) and 1(C), a dense and smooth surface was observed in the SCE membrane with a thickness of around 150 μm. As shown in FIG. 2, the LPS particles with a particle size of around 3-5 μm could be wrapped by the amorphous polymer, which is important for improving the air stability of the SCE to prevent the hydrolysis reactions with moisture in the ambient environment. FIG. 1(D) illustrates the Energy-dispersive spectroscopy (EDS) mapping images of fluorine (F), phosphorus (P), and sulfur (S) which further confirm the homogeneous distribution of LPS particles in the SCE membrane. FIG. 1(E) illustrates that the prepared SCE membrane is free-standing and mechanically flexible.

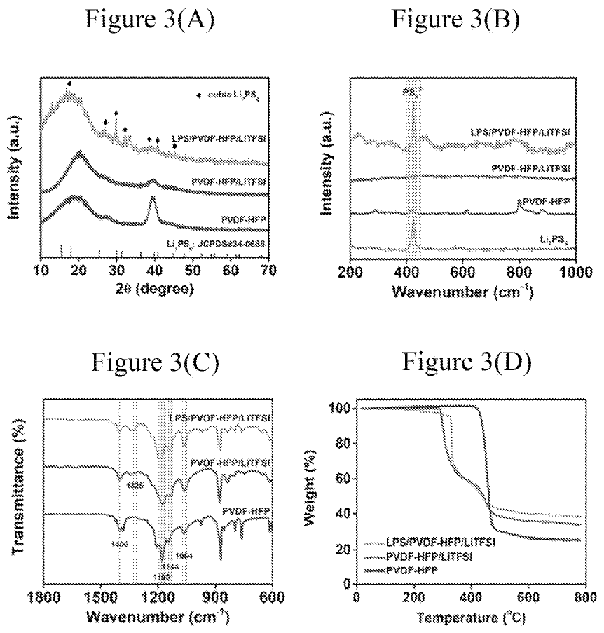

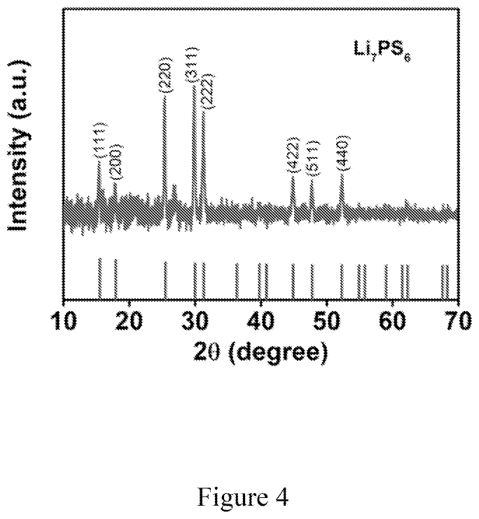

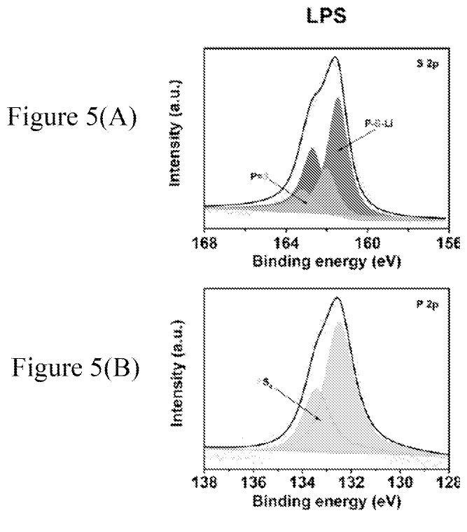

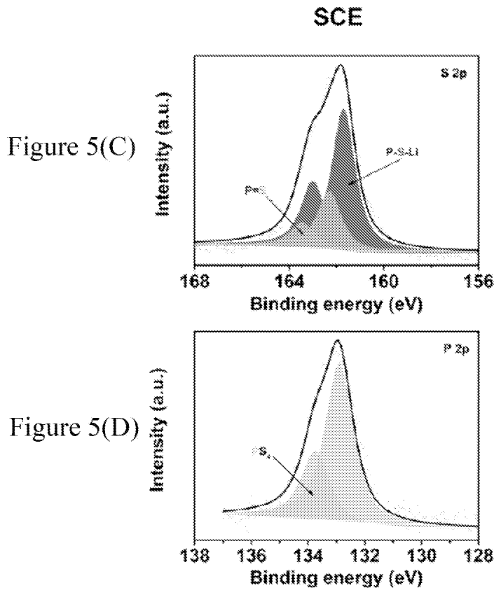

FIG. 3(A)-3(D) illustrate the comparison of the XRD pattern, Raman spectra, and Fourier transform infrared (FT-IR) spectra of SCE, PVDF-HFP/LiTFSI, LPS powder, and pure PVDF-HFP. In FIG. 3(A), the XRD patterns of SCE membranes are divided in two groups: (1) the diffraction peaks at 2θ=25, 30, and 31° corresponding to the diffraction planes of (220), (311), and (222) originating from the LPS with cubic structure (F4̅3̅m symmetry) 43; and (2) the diffraction peaks at around 20, 26, and 40° corresponding to the crystalline structure of PVDF-HFP. No additional peaks of LiTFSI salt were observed in SCE, suggesting that LiTFSI was completely dissolved in the polymer matrix. The XRD patterns of pure LPS powder are shown in FIG. 4 for comparison. Although the preparation of the SCE membrane was carried out in an ambient environment, the XRD results clearly indicate that the main crystalline structure of LPS still remained in the obtained SCE membrane, suggesting its desired stability when exposed to air. Moreover, with the presence of LPS fillers, the intensity of the diffraction peaks corresponding to PVDF-HFP significantly decreased as illustrated in FIG. 3(A), indicating reduced crystallinity of PVDF-HFP, which could facilitate the effective interactions between ion species and polymer chains. This could influence the PVDF-HFP recrystallization and result in more amorphous regions, which is favorable to ion conduction and transport in SCEs. As shown in FIG. 3(B), the Raman bonds of LPS display a characteristic peak at 421 cm⁻¹ attributing to the symmetric stretching vibration of the (PS₄)⁻³ (orthothiophosphate) group. After dispersing in polymer, the main characteristic peak of LPS is still displayed. Both XRD and Raman results show that the crystalline structure of LPS still remains in the SCE without breaking P—S bonds. This was further confirmed by the XPS spectra of S 2p and P 2p in FIGS. 5(A)-5(D). Compared to the XPS spectra of pure LPS, P—S bonds still remain in the prepared SCE. As shown in FIG. 3(C), the chemical interactions in the SCE were analyzed by FT-IR spectroscopy. The FT-IR spectra of the SCE membrane contain (1) a strong peak at 1190 cm⁻¹ corresponding to the stretching vibrations of the —CH₂ and —CH₃ groups from PVDF-HFP and (2) a characteristic peak at 1325 cm⁻¹ belonging to TFSF. Additionally, the peak at 1144 cm⁻¹ displayed in the SCE indicates the presence of interactions between dissociated Li⁺ and —CF₂ in PVDF-HFP.

FIG. 3(D) shows the TGA analysis for SCE and PVDF-HFP/LiTFSI membranes. There was negligible weight loss before 150° C., confirming the full removal of THF solvent during the preparation process. The decomposition temperature of PVDF-HFP was around 420° C. Upon adding LiTFSI into PVDF-HFP/LiTFSI, the decomposition temperature of the polymer decreased to around 300° C. due to the reduction in crystallinity degree and increase in amorphous regions in the polymer electrolyte. For the SCE membrane, the minor weight loss before thermal decomposition (˜350° C.) is likely due to the melting and gradual degradation of polymer due to the growth of amorphous fraction, resulting from the interactions between LPS, polymer, and LiTFSI. It is notable that the decomposition temperature of the SCE is slightly higher than that of PVDF-HFP/LiTFSI, indicating that LPS may have a positive effect on the thermal stability of the SCE. The weight reduction for both SCE and PVDF-HFP/LiTFSI after 350° C. is ascribed to the degradation of LiTFSI salt.

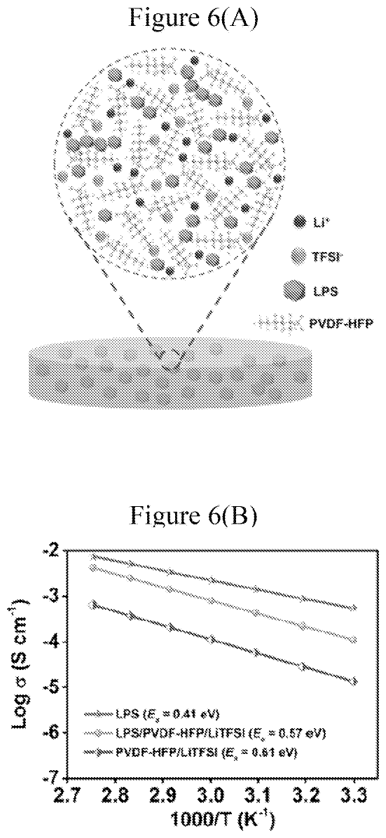

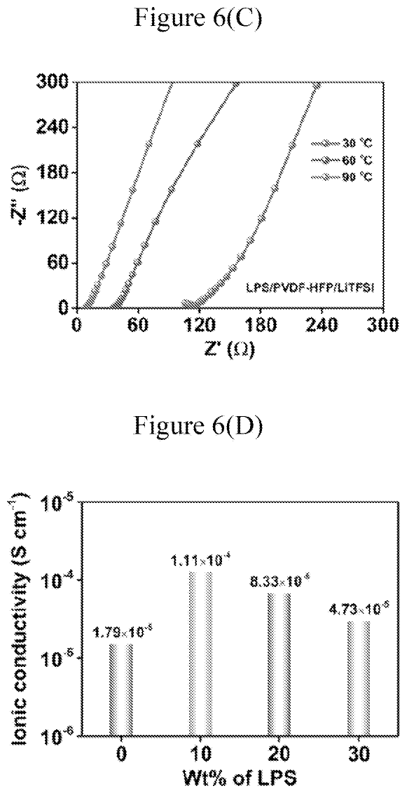

FIG. 6(A) is a schematic illustration of a SCE membrane that contains LPS, PVDF-HFP, and LiTFSI. As shown in FIG. 6(B), the ionic conductivity of the SCE with LPS fillers was obtained by EIS measurement and compared to the pristine LPS SE and PVDF-HFP/LiTFSI polymer electrolyte. All of the samples obeyed the Arrhenius equation, as follows:

σ(T)=σ₀ exp(−Eₐ/k_{B}T) Equation (1)

where Eₐ is the activation energy, k_{B} is the Boltzmann constant, and T is the temperature.

The ionic conductivity of the samples also increased linearly with increasing temperature. The room-temperature ionic conductivity of the PVDF-HFP/LiTFSI sample was 1.79×10⁻⁵ S cm⁻¹, much lower than that of pure LPS (2.0×10⁻⁴ S cm⁻¹). By combining these two components, the SCE with 10 wt % LPS exhibited higher ionic conductivity than pure polymer electrolyte likely due to the following reasons. First, the incorporation of LPS fillers and LiTFSI into PVDF-HFP reduces the crystallinity degree of polymer and increases the amorphous phase with flexible chains for faster ion mobility and better ion conduction (as shown in the XRD results in FIG. 3(A)). Second, effective interactions between LPS and PVDF-HFP could be enhanced to form Li-ion transport pathways and fast Li⁺ hopping due to percolation effect. In addition, for the PVDF-HFP/LiTFSI polymer electrolyte, Li ions diffuse in the amorphous phase with the assistance of chain segments of PVDF-HFP. It shows a high activation energy of 0.61 eV. By introducing LPS, the activation energy (0.57 eV) decreases, which accordingly suggests a diverse Li-ion conduction mechanism rather than random transport through amorphous polymer. FIG. 6(B) also demonstrates that pure LPS exhibits the lowest activation energy (0.41 eV). The Nyquist plots of the SCE with 10 wt % LPS at various temperatures (30, 60, and 90° C.) are shown in FIG. 6(C). As previously stated, in an exemplary embodiment, an SCE in accordance with embodiments described herein exhibits a desired ionic conductivity of 1.11×10⁻⁴ S cm⁻¹ at a temperature of 22° C. Alternatively, as shown in FIG. 6(B) and FIG. 6(C), the ionic conductivity of an SCE according to the embodiments herein is at least 3.5×10⁻⁴ S cm⁻¹ at 60° C. Alternatively, such ionic conductivity is at least 5×10⁻³ S cm⁻¹ at 90° C.

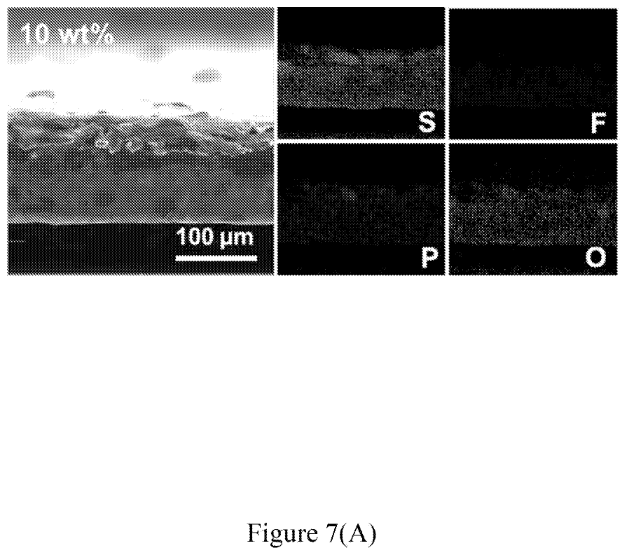

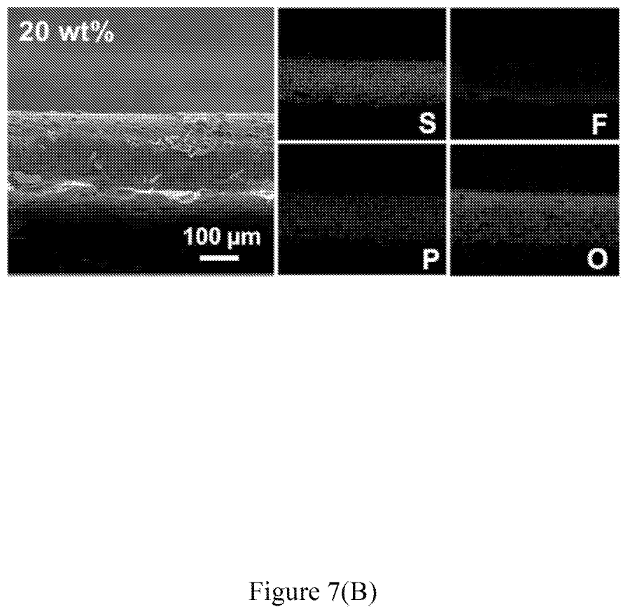

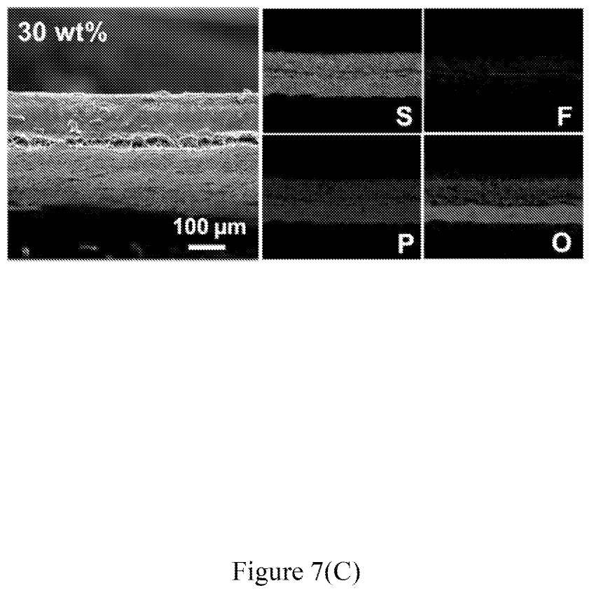

The typical Nyquist plot includes a semicircle at a high-frequency range and a spike at the end. In FIG. 6(C), the impedance decreased as the temperature increased. Additionally, as shown in FIG. 6(D), for all of the SCEs, as the LPS content increases, the ionic conductivity increases and then decreases after reaching the highest value of 1.11×10⁻⁴ S cm⁻¹ at 10 wt % LPS. When the content of LPS is too high, the ionic conductivity decreases because the aggregation of fillers leads to phase separation between LPS and PVDF-HFP, resulting in the disparity of Li distribution and slow Li-ion mobility. This is supported by the cross-sectional SEM images and EDS mappings of SCE membranes with various contents of LPS (10, 20, and 30 wt %, respectively) shown in FIGS. 7(A) to 7(C). As shown in FIG. 7(C), a clear phase separation was observed for the SCE containing 30 wt % LPS. Among different compositions, the SCE membrane with 10 wt % was selected for further electrochemical tests.

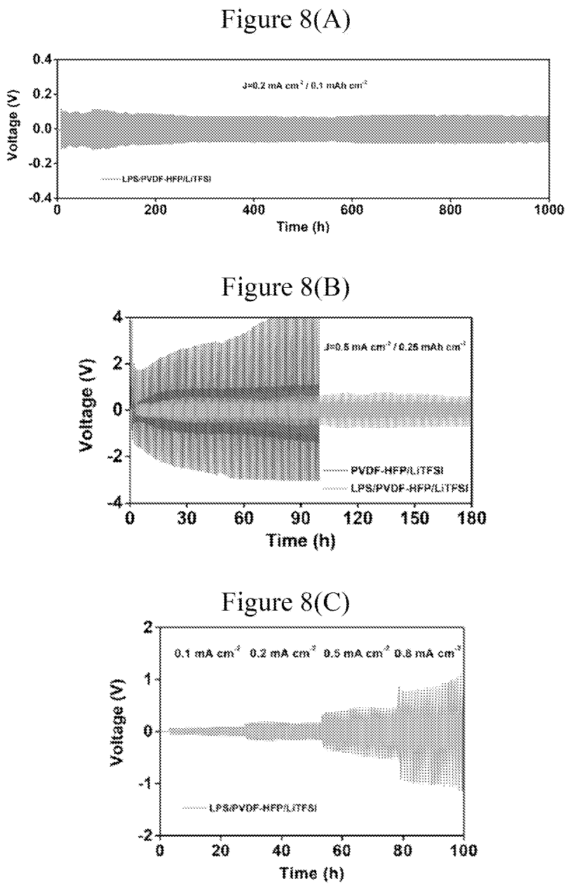

The electrochemical compatibility, particularly the long-term cycling stability of the SCE with Li anode, was evaluated through Li plating/stripping tests in symmetric cells under constant current densities. As shown in FIG. 8(A), the Li∥SCE∥Li symmetric cell under a current density of 0.2 mA cm⁻² exhibited a desirable stability with a flat polarization voltage over a period of time of at least 1000 h. In this context, a flat polarization voltage is characterized by a variance in voltage of no greater than 10% for such period of time. Under a current density from 0.2 to at least 0.8 mA cm⁻², it is anticipated that at least some SCE's within the scope of present embodiments would maintain a flat polarization voltage, as contemplated in the prior sentence, for a period of at least 1000 h.

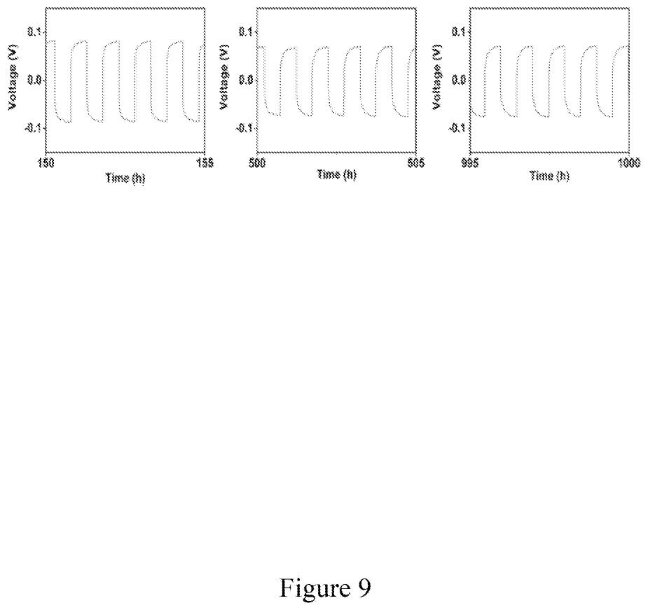

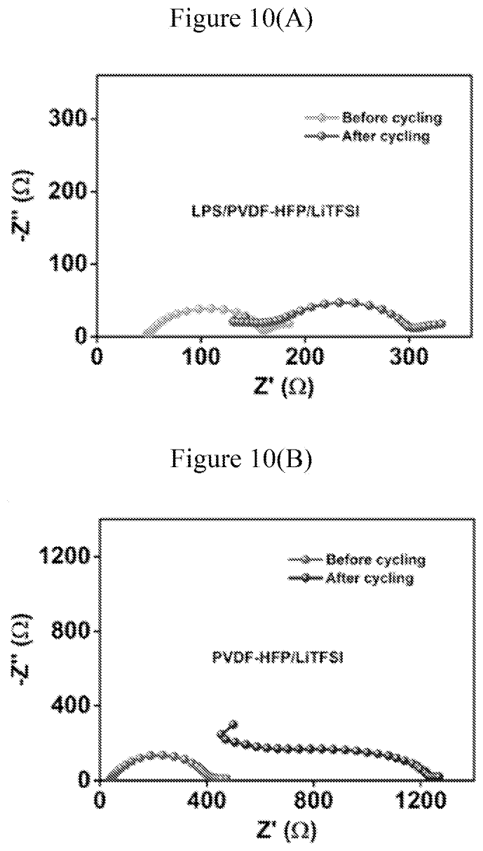

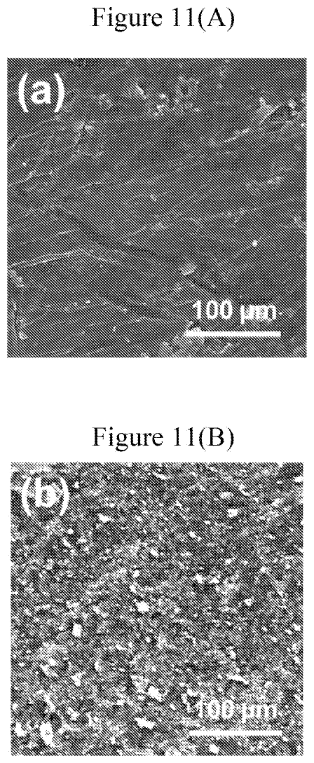

FIG. 9 illustrates the zoomed-in voltage profiles for typical cycles of Li symmetric cell with SCE under a current density of 0.2 mA cm⁻² (0.1 mAh cm⁻²). When the current density increased to 0.5 mA cm⁻² (0.25 mAh cm⁻²), the voltage profile of Li∥SCE∥Li symmetric cell was still stable and no sign of a short circuit was observed in FIG. 8(B), suggesting a stable interphase between the Li anode and the SCE. In contrast, the voltage values for the symmetric cell with PVDF-HFP/LiTFSI polymer electrolyte continuously increased, indicating an uneven interface formed due to the non-uniform Li deposition. This was further supported by EIS measurements and surface morphology studies. As shown in FIGS. 10(A) and 10(B), after cycling the cell with SCE showed a slight increase in resistance, while the resistance of the cell with PVDF-HFP/LiTFSI increased dramatically. As shown in FIGS. 11(A) and 11(B), the symmetric cells after cycling were disassembled and SEM images were collected from the Li surface. In FIG. 11(A), a uniform and smooth surface was observed without evidence of Li dendrite formation for the Li∥SCE∥Li symmetric cell. However, for the cell with the PVDF-HFP/LiTFSI polymer electrolyte in FIG. 11(B), the surface of the Li metal was rough and non-uniform with massive irregular Li dendrites. As illustrated in FIG. 8(C), the Li∥SCE∥Li symmetric cell was tested under different current densities (0.1, 0.2, 0.5, and 0.8 mA cm⁻²). With increasing current density, the voltage profiles increased due to the polarization, but the voltage hysteresis remained stable up to current density 0.8 mA cm⁻². As illustrated in FIGS. 8(A) to 8(C), the SCE presents desirable compatibility and stability with Li metal and superior dendrite-restraining ability, suggesting the SCEs according to multiple embodiments and alternatives are promising composite electrolyte candidates for use in solid-state Li metal batteries.

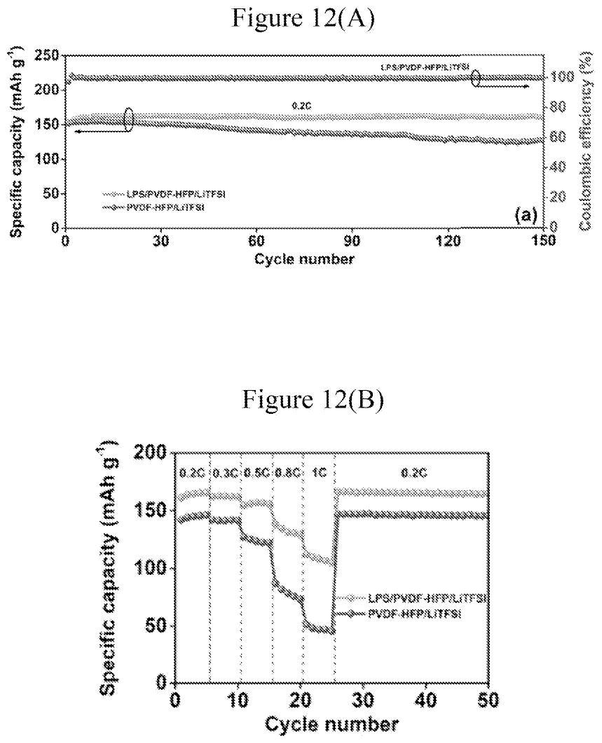

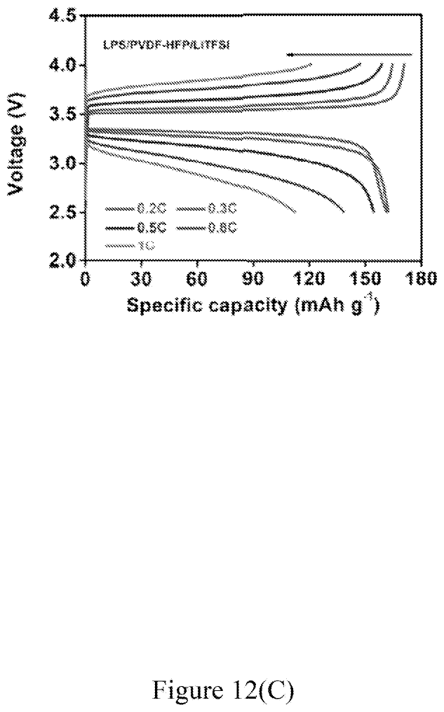

As shown in FIGS. 12(A)-12(C), LFP∥Li cells were assembled and cycled to evaluate the battery cycling performance using SCE and PVDF-HFP/LiTFSI as the electrolyte, respectively. In FIG. 12(A), the PVDF-HFP/LiTFSI-based cell showed an initial specific capacity of 154 mAh g⁻¹ at a C-rate of 0.2 C and a specific capacity of 112 mAh g⁻¹ after 150 charge/discharge cycles, which only maintained 72% of its initial capacity. In batteries, the discharge current is often expressed as a C-rate in order to normalize against battery capacity. A C-rate is a measure of the rate at which a battery is discharged relative to its maximum capacity. In comparison, a cell comprising an SCE based on the embodiments herein delivered a higher initial specific capacity of around 160 mAh g⁻¹ and a much improved capacity retention (98%) after 150 cycles. The coulombic efficiency of LFP∥SCE∥Li cell remained stable at ˜99.9% during the whole cycle process. The comparison of the rate capabilities of the LFP∥Li cells using the SCE and the PVDF-HFP/LiTFSI polymer electrolyte is illustrated in FIG. 12(B). The former exhibited much improved discharge capacities for all C rates, especially at high current rates. At 1 C, it delivered a discharge capacity of around 103 mAh g⁻¹, much better than the cell with PVDF-HFP/LiTFSI (50 mAh g⁻¹). Moreover, the specific capacity of the LFP∥SCE∥Li cell can recover from 1 C to 0.2 C, achieving around 160 mAh g⁻¹ for another 25 cycles. In FIG. 12(C), the voltage profiles of the LFP∥SCE∥Li cell at various current rates exhibited low-voltage polarizations, contributing to desirable electrochemical reversibility. The desired electrochemical performance of the LFP∥SCE∥Li cells could be associated with the improved ionic conductivity of the SCE and the enhanced interfacial properties between SCE and electrodes. The interface was further characterized by XPS studies to reveal the interfacial stability mechanism. In accordance with the embodiments provided for herein, Li-ion pouch cells comprising SCEs were fabricated with LFP and LTO (Li₄Ti₅O₁₂) as the cathode and anode, respectively. The LFP|SCE|LTO pouch cells showed an impressive ability to turn on an LED light at different states (flat, folded, and cut). These observations provide further indication that SCEs in accordance with multiple embodiments and alternatives could be applied in flexible solid-state lithium batteries with high safety.

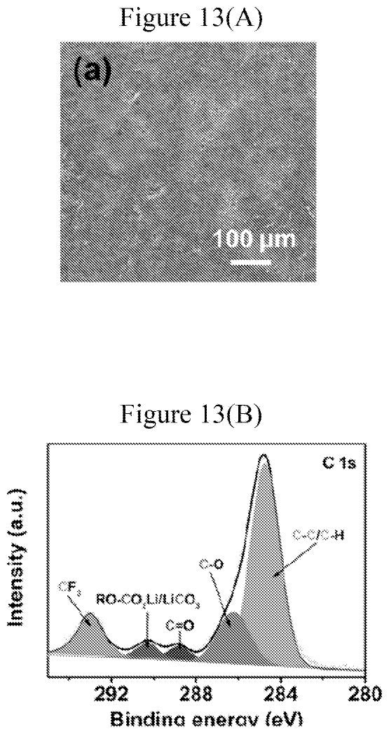

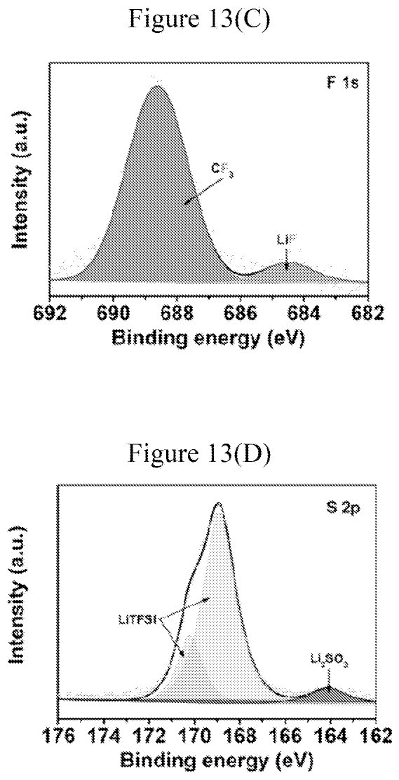

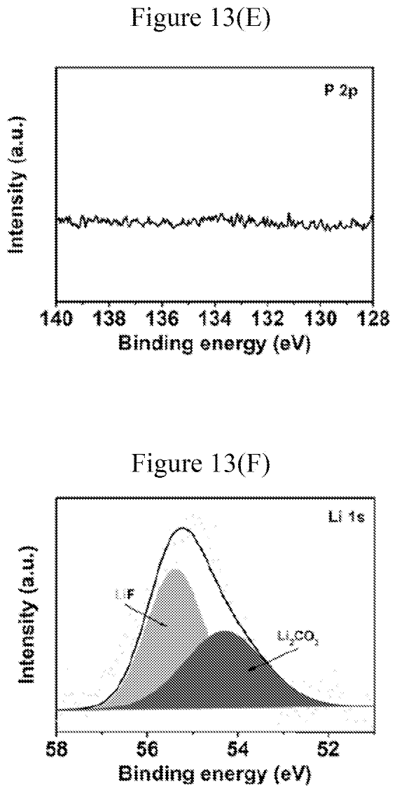

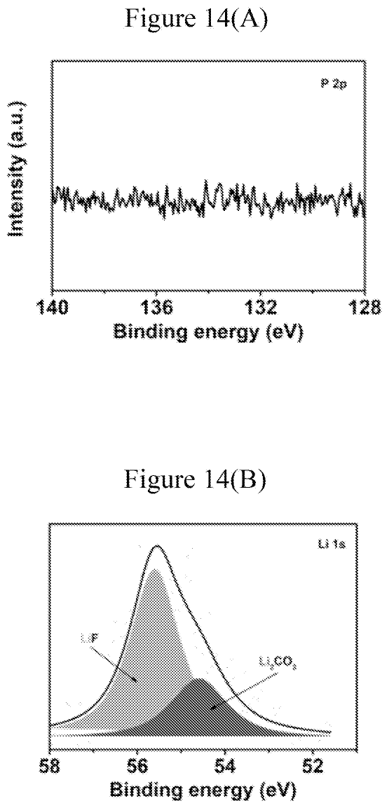

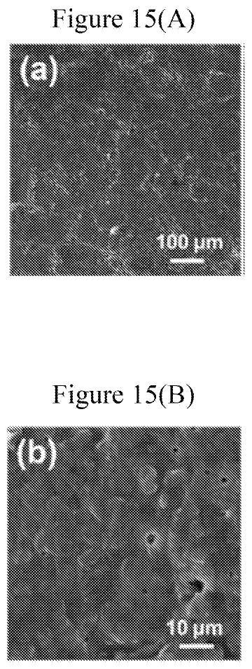

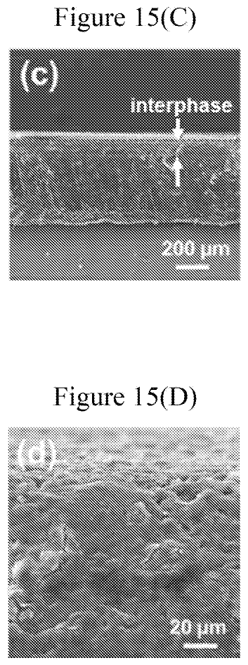

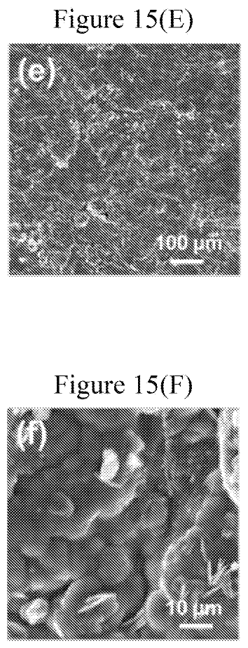

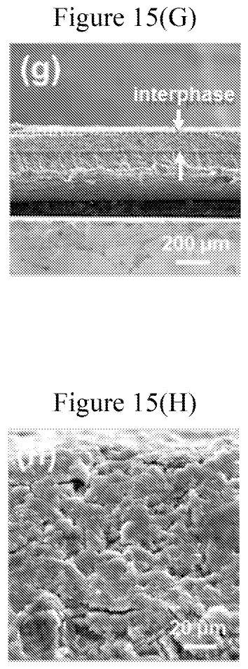

FIGS. 13(A) to 13(F) display the SEM image and XPS spectra for the Li anode surface that was disassembled from the LFP∥SCE∥Li cell after 150 charge/discharge cycles. The SEM image in FIG. 13(A) shows a smooth surface morphology. In the XPS spectra of C 1s, F 1s, S 2p, P 2p and Li is from Li anode surface shown in FIGS. 13(B) to 13(F), evident LiF, —CF₃, Li₂CO₃, and organic compounds were be observed, which come from the decomposition of carbonate and TFSI⁻ from liquid electrolyte (PC/LiTFSI). This is different from the reduction products (Li₂S and Li₃P) from the reaction between Li thiophosphate with Li metal, suggesting LPS is fully protected by PVDF-HFP. The presence of LiF at the interface also contributes to a stable SEI between the SCE and Li metal, leading to desirable cycling performance in Li symmetric cells and LFP/Li batteries. FIGS. 14(A) and 14(B) show the XPS spectra of Li anode in contact with PVDF-HFP/LiTFSI after cycling, which indicates similar interphase products with the Li anode with SCE. In addition, FIGS. 15(A) to 15(H) compare the interphase morphologies harvested from Li anodes with SCE and PVDF-HFP/LiTFSI. The interphase of the cycled lithium in contact with the SCE is slightly smoother and thinner than that with PVDF-HFP/LiTFSI, which indicates the use of the SCE could induce a better interphase. The desirable electrochemical performance of SCE demonstrates the synergic effect of inorganic LPS fillers and PVDF-HFP polymer: on the one hand, the polymer enhances the chemical stability of LPS and the electrochemical stability with electrode materials; on the other hand, inorganic fillers facilitate the Li-ion mobility as well as the cycling stability and the rate capacity of composite electrolyte.

### Example 2—Synthesis of Composite Electrolyte, Li₆PS₅Cl/PVDF-HFP/LiTFSI

Preparation of Composite Electrolyte—The sulfide lithium argyrodite was first synthesized in the same manner as Example 1. To synthesize the composite electrolyte, 0.2 g PVDF-HFP (Mw: 400 000, 99.9%, Sigma-Aldrich) was dissolved in 3 mL THF, and 0.1 g LiTFSI (99.99%, VWR) was dissolved in 1 mL THF by ultrasonic agitation to form a homogeneous solution. A desired amount of the sulfide (10, 20, and 30 wt %) was dispersed in 1 mL THF by ultrasonic to form a homogeneous suspension. Then the PVDF-HFP/LiTFSI in THF solution was mixed with the suspension of sulfide in THF, the mixture was sonicated for 3 h, and then casted onto a Petri dish. The SCE membrane was finally obtained by evaporating the THF at room temperature for 12 h and further in a vacuum oven for 6 h. The synthesized composite membrane had a thickness of about 120 μm.

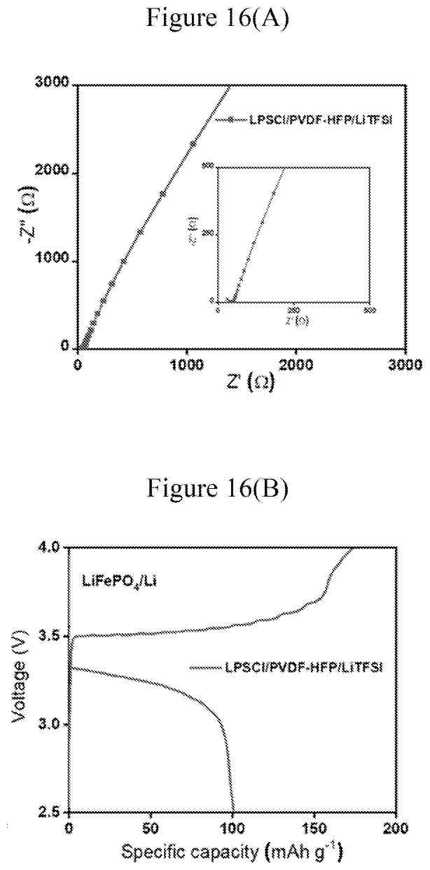

Characterizations— FIG. 16(A) shows the Nyquist plot of a Li₆PS₅Cl-PVDF-HFP/LiTFSI composite membrane at room temperature. The ionic conductivity was calculated to be ˜1.8×10⁻⁴ S cm⁻¹. FIG. 16(B) shows the cycling performance of a solid-state Li battery using Li metal as the anode, LiFePO₄ as the cathode, and Li₆PS₅Cl-PVDF-HFP/LiTFSI composite membrane as the solid electrolyte. This solid-state Li battery displayed a discharge capacity above 100 mAh g⁻¹ when cycling under 0.1 C.

### Example 3—Synthesis of Composite Electrolyte, Li₆PS₅Br/PVDF-HFP/LiTFSI

Preparation of Composite Electrolyte—The sulfide lithium argyrodite was synthesized according to wet chemical synthesis methods described herein. The SCE was then prepared by mixing the Li₆PS₅Br, PVDF-HFP, and LiTFSI in a THF solvent, casting, and then removing the THF solvent, in accordance with the embodiments described herein. The synthesized composite membrane had a thickness of about 140 μm.

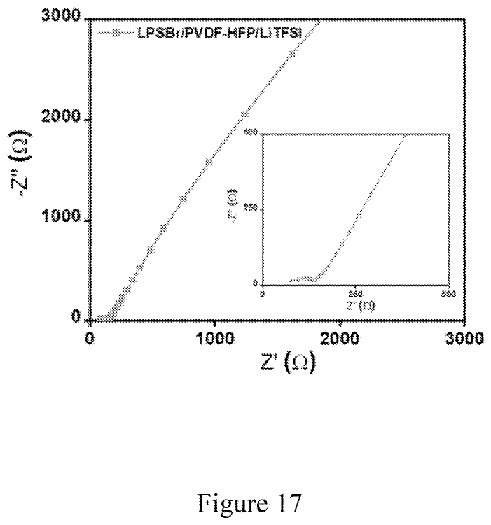

Characterization—FIG. 17 shows the Nyquist plot of a Li₆PS₅Br-PVDF-HFP/LiTFSI composite membrane at room temperature. The ionic conductivity of the composite electrolyte was calculated to be ˜1.1×10⁻⁴ S cm⁻¹.

### Example 4—Synthesis of Other Composite Electrolytes

The feasibility of other sulfide-polymer composite membranes was demonstrated, including the following membranes which were synthesized in accordance with the embodiments described herein: Li₆PS₅I/PVDF-HFP/LiTFSI; Li₇PS₅Cl₂/PVDF-HFP/LiTFSI; Li₆PS₅Cl_{0.5}Br_{0.5}/PVDF-HFP/LiTFSI; and Li₆PS₅Cl_{0.5}I_{0.5}/PVDF-HFP/LiTFSI. Each of these composite membranes have been prepared to be flexible and thin composite membranes, and each exhibit desirable ionic conductivities and discharge capacities.

Examples 1-4 demonstrated novel SCEs with desirable air stability and electrochemical performance by embedding inorganic sulfide into a PVDF-HFP polymer matrix. In this composite structure, the PVDF-HFP polymer likely protected the inorganic sulfide to prevent the hydrolysis reaction with moisture in ambient environment and the side reactions with electrode materials in solid-state batteries, resulting in desirable chemical and electrochemical stabilities. In turn, the presence of the inorganic sulfide lithium argyrodite facilitated the ion conduction in the SCEs by creating more amorphous regions, thus enhancing the electrochemical performance of the SCEs. As a result, the developed SCEs combined the merits of an inorganic sulfide lithium argyrodite and the PVDF-HFP polymer facilitated a symmetric cell with prolonged cycle life of up to 1000 h under 0.2 mA cm⁻². Moreover, the LFP∥SCE∥Li cells achieved desirable cycling capacities and rate performance. These beneficial features indicate that the SCEs, according to multiple embodiments and alternatives, are promising electrolyte candidates for use in solid-state Li batteries.

It will be understood that the embodiments described herein are not limited in their application to the details of the teachings and descriptions set forth, or as illustrated in the accompanying figures. Rather, it will be understood that the present embodiments and alternatives, as described and claimed herein, are capable of being practiced or carried out in various ways. Also, it is to be understood that words and phrases used herein are for the purpose of description and should not be regarded as limiting. The use herein of “including,” “comprising,” “e.g.,” “containing,” or “having” and variations of those words is meant to encompass the items listed thereafter, and equivalents of those, as well as additional items.

Accordingly, the foregoing descriptions of several embodiments and alternatives are meant to illustrate, rather than to serve as limits on the scope of what has been disclosed herein. The descriptions herein are not intended to be exhaustive, nor are they meant to limit the understanding of the embodiments to the precise forms disclosed. It will be understood by those having ordinary skill in the art that modifications and variations of these embodiments are reasonably possible in light of the above teachings and descriptions.

What is claimed is:

1. A sulfide composite electrolyte, comprising an inorganic sulfide lithium argyrodite and a polymer.

2. The sulfide composite electrolyte of claim 1, further comprising a lithium salt.

3. The sulfide composite electrolyte of claim 1, wherein the inorganic sulfide lithium argyrodite is chosen from the group consisting of LiₘPSₙXₒ, LiₘPSₙXₒYₒ and LiₘPSₙ, where m is a number in the range of 6-7, n is a number in the range of 5-6, X represents at least one halide, Y represents at least one halide other than X, and o is a number in the range of 0-2.

4. The sulfide composite electrolyte of claim 1, wherein the polymer is chosen from the grouping consisting of fluorinated polymers, methyl methacylate-based polymers, vinyl polymers, and ethylene-based polymers.

5. The sulfide composite electrolyte of claim 2, wherein the lithium salt is chosen from the group consisting of LiTFSI, LiFSI, and LiPF₆.

6. An electrochemical energy storage device having a membrane comprising a sulfide composite electrolyte according to claim 1, wherein the membrane is characterized by one of an ionic conductivity of at least 1.1×10⁻⁴ S cm⁻⁴ at 22° C., or an ionic conductivity of at least 3.5×10⁻⁴ S cm⁻¹ at 60° C., or an ionic conductivity of at least 5×10⁻³ S cm⁻¹ at 90° C.

7. The electrochemical energy storage device of claim 6, wherein the device when cycling at a C-rate of 0.2 C is characterized by a specific capacity of at least 160 mAh g⁻¹ after at least 150 cycles of charge/discharge.

8. The electrochemical energy storage device of claim 6, wherein the device when under a current density of 0.2-0.8 mA cm⁻² exhibits a flat polarization voltage marked by a variance in voltage of no greater than 10% over a period of time of at least 1000 hours.

9. The electrochemical energy storage device of claim 6, wherein the device is a solid-state lithium metal battery.

10. A method for synthesizing a sulfide composite electrolyte, comprising:
mixing an inorganic sulfide lithium argyrodite, a polymer, and a lithium salt in a solvent to form a mixed solution;
casting the mixed solution on a surface; and
evaporating the solvent by at least one of drying the mixed solution above 22° C. or by exposing the mixed solution to a low humidity/oxygen-less environment.

11. The method of claim 10, wherein exposing the low humidity/oxygen-less environment is characterized by a relative humidity between 0-40% and an oxygen level between 0-20 vol %, and further comprising, after the evaporating step annealing the mixed solution in the low humidity/reduced oxygen environment.

12. The method of claim 10, wherein the inorganic sulfide lithium argyrodite is chosen from the group consisting of LiₘPSₙXₒ, LiₘPSₙXₒYₒ and LiₘPSₙ, where m is a number in the range of 6-7, n is a number in the range of 5-6, X represents at least one halide, Y represents at least one halide other than X, and o is a number in the range of 0-2.

13. The method of claim 10, wherein the polymer is chosen from the grouping consisting of polyvinylidenefluoride-co-hexafluoropropylene, polyvinylidene fluoride, poly(ethylene oxide), poly(methylmethacrylate), and polyacrylonitrile.

14. The method of claim 13, wherein the polymer is polyvinylidenefluoride-co-hexafluoropropylene.

15. The method of claim 10, wherein the lithium salt is bis(trifluoromethanesulfonyl)imide.
